(19) United States
(12) Patent Application Publication
(10) Pub. No.: US 2018/0218423 A1
(43) Pub. Date: Aug. 2, 2018

(54) ONLINE HVAC PURCHASING SYSTEM

(71) Applicant: Erik Bryan, Gilbert, AZ (US)

(72) Inventor: Erik Bryan, Gilbert, AZ (US)

(21) Appl. No.: 15/885,407

(22) Filed: Jan. 31, 2018

Related U.S. Application Data
(60) Provisional application No. 62/453,208, filed on Feb. 1, 2017.

(51) Int. Cl. G06Q 30/06; G06F 17/30

(52) U.S. Cl. CPC G06Q 30/0623; G06Q 20/12; G06F 17/30867

(57) ABSTRACT

An online HVAC purchase system is provided. The system allows a consumer or user to select a new HVAC system suitable for the user's home or building, select a contractor and purchase the unit and contractor services independently. The system includes a computer server and a user computing device coupled together, wherein the user computing device operates a web browser to access the system. The computer server is programmed to step the user through a series of filtering questions in order to identify automatically an appropriate new HVAC unit for purchase by the user and installation by the contractor.

### CROSS REFERENCE TO RELATED APPLICATIONS

This application claims priority to U.S. Provisional Patent Application entitled “ONLINE HVAC PURCHASING SYSTEM,” Ser. No. 62/453,208, filed Feb. 1, 2017, the disclosure of which is hereby incorporated entirely herein by reference.

### BACKGROUND OF THE INVENTION

### Technical Field

This invention relates generally to an HVAC purchasing system and more specifically to an online HVAC purchasing system.

### State of the Art

The purchasing of an HVAC system is typically accomplished by contacting a contractor that installs HVAC systems. The customer works with the contractor to determine the type and size of the unit for the home or building that is requiring the new system. The customer purchases the new unit along with the installation services of the contractor. Generally, the contractors are adept at installing certain manufacturer units and accordingly, the unit purchased from the contractor is one that they can install easily. It is generally an expensive process.

### SUMMARY OF THE INVENTION

The present invention relates to an online HVAC purchase system that allows a consumer or user to select a new HVAC system suitable for the user's home or building, select a contractor and purchase the unit and contractor services independently.

An embodiment includes an online HVAC purchasing system, the system comprising: (a) a computer server located at a seller, the computer server comprising a memory containing data of HVAC units for sale; (b) a user computing device having a network connection and operating a web browser, wherein the user computing device accesses the system through operation of the web browser to couple the user computing device to the computer server and wherein the computer server is programmed to: (i) receive from the web browser of the user computing device a user zip code associated with the user and automatically save the user zip code within the memory; (ii) automatically determine if the user is located within a predetermined geographic region serviced by the system in response to processing the user zip code and comparing the user zip code to stored zip codes associated with the predetermined geographic region to validate the user is located within the predetermined geographic region; (iii) in response to validating the user, automatically display in the web browser on the user computing device filter questions; (iv) receive from the web browser of the user computing device filter data in response to answering the filter questions and automatically store the filter data in the memory of the computer server; (v) automatically determine HVAC unit models that match the filter data and automatically display in the web browser of the user computing device the HVAC unit models; (vi) in response to receiving a selection of an HVAC unit model for purchase and receiving an indication to check out from the web browser of the user computing device, automatically generating and displaying on the web browser of the user computing device a list of contractors associated with the user zip code; (vii) in response to receiving a selection of a contractor from the list of contractors, automatically generate and display billing and installation pages in the web browser until payment of the HVAC unit is processed by the system; and (viii) in response to receiving payment for the HVAC unit, automatically generate and send an email with purchase details of the HVAC unit and send an email with contractor information. Along every step of the process there are helps that take the form of either videos, diagrams, written directions and/or a personal contact in real time to assist the customer through the process and to help them answer the questions.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of an online HVAC purchasing system, in accordance with embodiments; and

FIG. 2 is a flow chart of a method of operating an online HVAC purchasing system, in accordance with embodiments.

### DETAILED DESCRIPTION OF EMBODIMENTS OF THE INVENTION

As discussed above, embodiments of the present invention relate to an online HVAC purchase system that allows a consumer or user to select a new HVAC system suitable for the user's home or building, select a contractor and purchase the unit and contractor services independently.

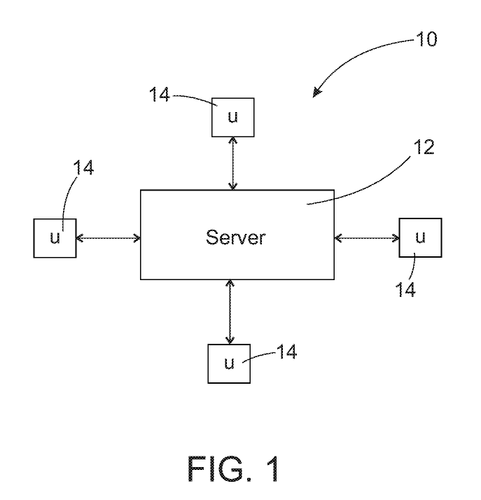

FIG. 1 depicts an embodiment of an online HVAC purchasing system 10. Generally, the system 10 includes a computer server 12 having a memory and processor and programmed to operate the system 10. The system 10 further includes user computing device(s) 14 coupled to the computer server 12. The user computing device 14 may be coupled to the computer server 12 through a network connection, such as an Internet connection through any available protocols and means. The user computing device 14 may also access the system operated by the server 12 through a web browser displayed on the user computing device 14.

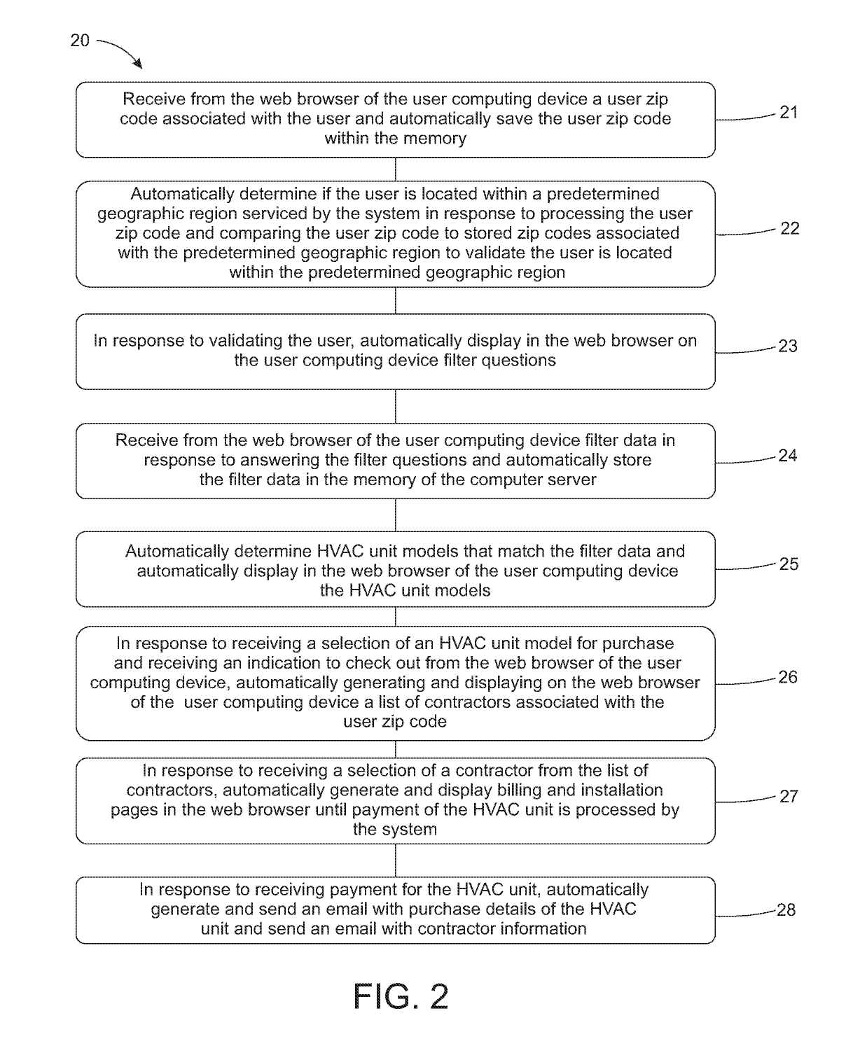

Referring to FIG. 2, operation of the system 10 may include the computer server 12 programmed to perform certain functions and operations. The flow chart of FIG. 2 depicts a program 20, wherein the computer server 12 may be programmed to receive from the web browser of the user computing device a user zip code associated with the user and automatically save the user zip code within the memory as depicted in Block 21. In embodiments, the web browser accessed by the user computing device 14 may include a data entry box or the like, wherein the user may input the zip code of the user or the zip code for the installation of an HVAC unit.

The computer server 12 may be programmed to automatically determine if the user is located within a predetermined geographic region serviced by the system in response to processing the user zip code and comparing the user zip code to stored zip codes associated with the predetermined geographic region to validate the user is located within the predetermined geographic region as depicted in Block 22. The predetermined geographic region may include various zip codes that the seller of the new HVAC units employing the system 10 has established. In some embodiments, the seller may establish partnerships or business relationships with contractors in particular zip codes, utilize these business relationships to establish the zip codes that form the predetermined geographic region.

The computer server 12 may be programmed to, in response to validating the user, automatically display in the web browser on the user computing device filter questions as depicted in Block 23. The filter questions may be utilized to narrow the possible selections of new HVAC units to fulfill the user's needs and/or requirements. The filter questions may include a question regarding type of HVAC unit installed on the building. This may be what is currently installed, such as but not limited to a split unit or a packaged unit and if split if a portion is in the attic or a closet. The filter questions may include a question regarding a heat source type, such as gas or electric forced. The filter questions may include a question regarding tonnage, wherein the tonnage is based on the size of the home or building that is to be cooled and/or heated.

The computer server 12 may be programmed to receive from the web browser of the user computing device filter data in response to answering the filter questions and automatically store the filter data in the memory of the computer server as depicted in Block 24. The computer server 12 can be programmed with helps that take the form of either, audio, videos, diagrams, written directions, personal contact in real time or any other form to assist the customer through the process and to help them answer the questions accurately. If preferred the web browser of the user can be used to send electronic images of the customer's existing HVAC unit(s) to the computer server 12 for viewing by someone at computer server 12 to assure that the questions are being answered correctly.

Once the filter data is stored, the computer server 12 of the system 10 may be programmed to automatically determine HVAC unit models that match the filter data and automatically display in the web browser of the user computing device the HVAC unit models as depicted in Block 25. These HVAC unit models may be from varying brands that have the same or similar function, cooling capacity and otherwise meet the criteria established by the filter data. Once these products are displayed, the system 10 may allow the user to utilize the user computing device 14 to further filter based on price, brand, user ranking, seer rating and the like.

The computer server 12 may be programmed to, in response to receiving a selection of an HVAC unit model for purchase and receiving an indication to check out from the web browser of the user computing device, automatically generating and displaying on the web browser of the user computing device a list of contractors associated with the user zip code as depicted in Block 26. The contractors as described above partnered with the seller may be displayed. The system 10 operating to partner and utilize licensed contractors within the geographic region that the user is having the installation allows for the warranty of the HVAC unit to stay intact.

The computer server 12 may be programmed to, in response to receiving a selection of a contractor from the list of contractors, automatically generate and display billing and installation pages in the web browser until payment of the HVAC unit is processed by the system, as depicted in Block 27.

The computer server 12 may be programmed to, in response to receiving payment for the HVAC unit, automatically generate and send an email with purchase details of the HVAC unit and send an email with contractor information. The email with contractor information may be sent as if from the contractor and allowing the user to communicate directly with the contractor. The seller was paid as payment was issued through the system. The system 10 places the user in contact with the licensed contractor. The licensed contractor may then perform an inspection and make any onsite adjustments as needed. At that point, the user may pay the contractor. This allows the system to operate to have payment for the HVAC unit independent from payment of the contractor. This results in a much less expensive manner of obtaining and installing a new HVAC unit.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An online HVAC purchasing system, the system comprising:
(a) a computer server located at a seller, the computer server comprising a memory containing data of HVAC units for sale;
(b) a user computing device having a network connection and operating a web browser, wherein the user computing device accesses the system through operation of the web browser to couple the user computing device to the computer server and wherein the computer server is programmed to:
(i) receive from the web browser of the user computing device a user zip code associated with the user and automatically save the user zip code within the memory;
(ii) automatically determine if the user is located within a predetermined geographic region serviced by the system in response to processing the user zip code and comparing the user zip code to stored zip codes associated with the predetermined geographic region to validate the user is located within the predetermined geographic region;
(iii) in response to validating the user, automatically display in the web browser on the user computing device filter questions;
(iv) receive from the web browser of the user computing device filter data in response to answering the filter questions and automatically store the filter data in the memory of the computer server;
(v) automatically determine HVAC unit models that match the filter data and automatically display in the web browser of the user computing device the HVAC unit models;
(vi) in response to receiving a selection of an HVAC unit model for purchase and receiving an indication to check out from the web browser of the user computing device, automatically generating and displaying on the web browser of the user computing device a list of contractors associated with the user zip code;
(vii) in response to receiving a selection of a contractor from the list of contractors, automatically generate and display billing and installation pages in the web browser until payment of the HVAC unit is processed by the system; and
(viii) in response to receiving payment for the HVAC unit, automatically generate and send an email with purchase details of the HVAC unit and send an email with contractor information.

2. The system of claim 1, wherein the filter questions include a question regarding type of HVAC unit installed on the building.

3. The system of claim 1, wherein the filter questions include a question regarding a heat source type.

4. The system of claim 1, wherein the filter questions include a question regarding tonnage.
